(19) United States
(12) Patent Application Publication
(10) Pub. No.: US 2021/0359374 A1
(43) Pub. Date: Nov. 18, 2021

(54) BATTERY SYSTEM AND VEHICLE INCLUDING THE BATTERY SYSTEM

(71) Applicant: Samsung SDI Co., Ltd., Yongin-si (KR)

(72) Inventors: Wolfgang REINPRECHT, Attendorf (AT); Matthias PUCHER, Lebring (AT); Miran KOJC, Hausmannstätten (AT); Michael ERHART, Seiersberg-Pirka (AT)

(21) Appl. No.: 17/316,549

(22) Filed: May 10, 2021

(30) Foreign Application Priority Data
May 12, 2020 (EP) 20174163.4
May 10, 2021 (KR) 10-2021-0060108

(51) Int. Cl. H01M 50/358; B60K 1/04; H01M 50/209

(52) U.S. Cl. CPC H01M 50/358; H01M 2220/20; H01M 50/209; B60K 1/04

(57) ABSTRACT

A battery system includes: battery cells; and a battery housing including: a chamber between a bottom cover and a top cover of the battery housing; and at least one sidewall member connecting the bottom cover and the top cover to each other, the at least one sidewall member extending along an outer boundary of the chamber, and including: a channel inside the sidewall member; and apertures connecting the chamber with the channel, the apertures being located at a top half of the channel such that at least a bottom half of the channel is for collecting solid matter. The battery system vents a venting gas of a thermal runaway from at least one of the battery cells by directing the venting gas along at least one venting path leading from the chamber, through at least one of the apertures and the channel, and to an environment of the battery system.

### CROSS-REFERENCE TO RELATED APPLICATION

This application claims priority to and the benefit of European Patent Application No. 20174163.4, filed in the European Patent Office on May 12, 2020, and Korean Patent Application No. 10-2021-0060108 filed in the Korean Intellectual Property Office on May 10, 2021, the entire content of both of which is incorporated herein by reference.

### BACKGROUND

### 1. Field

Aspects of one or more embodiments of the present disclosure relate to a battery system configured to separate solid matter from venting gas in case of a thermal runaway. Aspects of one or more embodiments of the present disclosure relate to a vehicle including the battery system.

### 2. Description of Related Art

In the recent years, vehicles for transportation of goods and people have been developed using electric power as a source for motion. Such an electric vehicle is an automobile that is propelled by an electric motor using energy stored in rechargeable batteries. An electric vehicle may be solely powered by batteries, or may be a form of a hybrid electric vehicle (e.g., a hybrid vehicle) powered by, for example, a gasoline generator. Furthermore, the vehicle may include a combination of an electric motor and a combustion engine (e.g., a conventional combustion engine). In general, an electric-vehicle battery (EVB) or traction battery is a battery used to power the propulsion of battery electric vehicles (BEVs). Electric vehicle batteries differ from starting, lighting, and ignition batteries, because they are designed to give power over sustained periods of time. A rechargeable or secondary battery differs from a primary battery in that it can be repeatedly charged and discharged, while the latter provides only an irreversible conversion of chemical to electrical energy. Low-capacity rechargeable batteries are used as power supply for small electronic devices, for example, such as cellular phones, notebook computers, and camcorders, while high-capacity rechargeable batteries are used as the power supply for hybrid electric vehicles and the like.

In general, rechargeable batteries include an electrode assembly including a positive electrode, a negative electrode, and a separator interposed between the positive and negative electrodes, a case for receiving the electrode assembly, and an electrode terminal electrically connected to the electrode assembly. An electrolyte solution is provided in the case in order to enable charging and discharging of the battery via an electrochemical reaction of the positive electrode, the negative electrode, and the electrolyte solution. The shape of the case (e.g. cylindrical or rectangular) depends on the battery's intended purpose. Battery cells with rectangular cases are also known as prismatic battery cells. Lithium-ion (and similar lithium polymer) batteries, which are widely known via their use in laptops and consumer electronics, dominate the most recent group of electric vehicles in development.

A battery module may be formed of a plurality of unit battery cells, by connecting their electrode terminals in series and/or in parallel, so as to provide a desired voltage.

A battery (also called a battery pack) is a set of any suitable number of battery modules or battery cells (which may be identical or substantially identical to each other, or may be different from each other). These battery modules or battery cells may be connected in series, in parallel, or a mixture of both to deliver a desired voltage.

Mechanical integration of such a battery may use appropriate mechanical connections between the individual components (e.g. of battery modules or battery cell rows), and a supporting structure of the vehicle. The battery modules or battery cell rows may be confined by cell holders (e.g., fastening side plates) to sidewall members (e.g., lateral sidewall members) of the carrier framework. Further, a top cover and a bottom cover (e.g., housing cover plates) may be fixed atop and below the battery modules or battery cell rows, respectively.

The carrier framework of the battery is mounted to a carrying structure of the vehicle. In case the battery is fixed at the bottom of the vehicle, the mechanical connection may be established from a bottom side, for example, by bolts passing through the carrier framework of the battery. The framework is usually made of aluminum or an aluminum alloy to lower the total weight of the construction.

Generally, battery systems, despite any modular structure, usually include a battery housing that serves as an enclosure to seal the battery system against an environment (e.g., an external environment), and provide structural protection of the battery system's components. Housed battery systems are usually mounted as a whole into their application environment, for example, such as an electric vehicle.

To provide thermal control of the enclosed battery cells within the battery housing, a thermal management system may be used to efficiently emit, discharge, and/or dissipate heat generated within the battery housing. In certain conditions of the battery cells, an increase of the internal temperature may lead to abnormal reactions occurring in the battery cells. An example of such abnormal operation conditions is a thermal runaway in a battery cell that may be entered by a strongly overheated or overcharged cell. The thermal runaway is a self-accelerating chemical reaction inside the battery cell, which produces high amounts of heat and venting gas, until all available material is exhausted. The exhausted material (e.g., venting products) may include hot and toxic venting gas, as well as conductive solid matter (e.g., material), for example, like graphite powder and metal fragments.

A thermal runaway may cause a thermal propagation along the battery cells of a battery module or battery, which could eventually lead to a fire.

A state of the art venting concept of a battery is to allow the hot venting gas of a battery cell in a thermal runaway condition to expand into the battery housing, and to escape through a housing venting valve to the outside (e.g., the environment of the battery housing).

As the hot venting gas may also include metallic parts of the battery cell as well as graphite, the thermal runaway in one battery cell may cause short circuits, and thus, a consecutive thermal runaway of other battery cells, which may lead to a complete damage of the battery (e.g., the battery pack), the battery system, and the vehicle.

The pollution caused by graphite and metallic parts may affect most of the battery cells or battery modules of a battery, and may lead to short circuits, because all battery cells or modules are within the same battery housing. Depending on the location of the battery cell in the thermal runaway with respect to the housing venting valve, different air streams may develop and cause different portions of the battery to be affected.

Accordingly, it may be desirable to overcome or reduce at least some of the above-discussed drawbacks, and to provide an improved thermal runaway handling battery system.

The above information disclosed in this Background section is for enhancement of understanding of the background of the present disclosure, and therefore, it may contain information that does not constitute prior art.

### SUMMARY

One or more embodiments of the present disclosure are directed to a battery system including a plurality of battery cells, and a battery housing with improved thermal runaway handling. One or more embodiments of the present disclosure are directed to a vehicle including the battery system.

According to one or more embodiments of the present disclosure, a battery system includes: a plurality of battery cells; and a battery housing including: a chamber between a bottom cover and a top cover of the battery housing, the chamber being configured to accommodate the plurality of battery cells; and at least one sidewall member connecting the bottom cover and the top cover to each other, the at least one sidewall member extending along an outer boundary of the chamber, and including: a channel inside the sidewall member; and apertures connecting the chamber with the channel, the apertures being located at a top half of the channel such that at least a bottom half of the channel is configured for collecting solid matter. The battery system is configured to vent a venting gas of a thermal runaway from at least one of the battery cells by directing the venting gas along at least one venting path leading from the chamber, through at least one of the apertures and the channel, and to an environment of the battery system.

In an embodiment, the at least one sidewall member may include at least one gas guiding means inside the channel of the at least one sidewall member, the at least one gas guiding means being configured to deflect the venting gas exiting the chamber through at least one of the apertures into a longitudinal direction of the channel along the at least one venting path.

In an embodiment, the at least one gas guiding means may partially cover the at least one aperture, and may extend from an upstream edge of the at least one aperture into the channel.

In an embodiment, the at least one gas guiding means may include a fin.

In an embodiment, the at least one gas guiding means may be integrally formed with the at least one sidewall member.

In an embodiment, a hollow space may be defined between the battery cells and the top cover.

In an embodiment, the battery housing may include at least one partition wall extending from the at least one sidewall member through the chamber to separate the chamber into at least two sub chambers.

In an embodiment, the at least one sidewall member may include two sidewall members extending along opposite outer boundaries of the chamber.

In an embodiment, the at least one sidewall member may include at least one aperture venting valve closing at least one of the apertures, and configured to open according to a pressure inside the chamber.

In an embodiment, the at least one sidewall member may include: an outlet port located at the top half of the channel; and a retention wall blocking at least the bottom half of the channel.

In an embodiment, the at least one sidewall member may include at least one rib located inside the bottom half of the channel transverse to a longitudinal direction of the channel.

In an embodiment, the battery system may further include a particle separator in the at least one venting path downstream of the channel.

In an embodiment, the particle separator may include a centrifugal separator.

In an embodiment, a vehicle may include the battery system.

In an embodiment, the at least one venting path may be configured to exit the vehicle at a front of a passenger cabin of the vehicle.

In some embodiments, the battery housing may include a chamber arranged between a bottom cover and a top cover of the battery housing. The chamber may accommodate the plurality of battery cells. Therefore, a top of the chamber may be sealed by the top cover, which forms (e.g., which constitutes) an upper housing cover, while a bottom of the chamber may be sealed by the bottom cover, which forms (e.g., which constitutes) a lower housing cover.

In some embodiments, the battery housing may further include at least one sidewall member connecting the bottom cover and the top cover to each other. The at least one sidewall member may extend along an outer boundary of the chamber. In other words, at least one side of the chamber, which is arranged between the bottom cover and the top cover, may be closed by the at least one sidewall member. The at least one sidewall member may include a sidewall profile, for example, such as a sidewall frame profile, which not only closes an area between the bottom cover and the top cover, but also provides structural stiffness to the housing.

In some embodiments, the at least one sidewall member may include a channel inside the sidewall member, and apertures connecting the chamber with the channel. The apertures may be arranged in a top half of the channel (e.g., next to or adjacent to the top cover), such that at least a bottom half of the channel (e.g., next to or adjacent to the bottom cover) is adapted for collecting solid matter. In other words, at least the bottom half of the channel is adapted as a collecting channel, for example, such as a collecting tray. The apertures, which connect the chamber with the channel inside the sidewall member, may be referred to as perforations through an inner wall of the sidewall member. Despite the apertures, however, the inner wall separates the chamber from the channel. The apertures may be arranged in a top half of the channel, which means that the apertures do not extend below the top half of the channel. Therefore, at least the bottom half of the channel is separated from the chamber by the closed inner wall of the at least one sidewall member. For example, the apertures may be arranged in a top third of the channel, such as in a top quarter of the channel, which means that the apertures do not extend below the top third or top quarter of the channel. Therefore, at least bottom two thirds of the channel, for example at least bottom three quarters of the channel, may be adapted for collecting solid matter. Therefore, at least the bottom two thirds of the channel, for example, at least the bottom three quarters of the channel, may be separated from the chamber by the closed inner wall of the at least one sidewall member. In some embodiments, the apertures are only arranged in (or in other words, restricted to) a top (e.g., upper) half, third, or quarter of the channel. Therefore, the at least bottom (e.g., lower) half, two thirds, or three quarters of the channel may be separated from the chamber, such that a collecting channel is realized. The collection of solid matter within the channel may be facilitated, as the channel may also function as an expansion chamber, which slows down a venting gas flow exiting the apertures.

The terms “top half”, “top third”, “top quarter”, “bottom half”, “bottom two thirds”, or “bottom three quarters” denominate portions of the channel. The top half together with the bottom half, the top third together with the bottom two thirds, and/or the top quarter together with the bottom three quarters of the channel form one channel (e.g., one single channel). Thus, gas and/or solid matter may move between the top and bottom portions of the channel. Therefore, the venting gas may enter the channel via the top half, top third, or top quarter of the channel, and the solid matter may settle to the bottom of the channel within the bottom half, bottom two thirds, or bottom three quarters of the channel.

In some embodiments, the battery system may be adapted, such that in case of a thermal runaway, venting gas vented from at least one of the battery cells is directed along at least one venting path leading from the chamber, through at least one of the apertures and the channel within the at least one sidewall member, and to an environment (e.g., an external environment) of the battery system. In other words, the battery system may include at least one venting path, which leads from the chamber to an environment (e.g., an external environment) of the battery system, and is adapted to direct the venting gas vented from at least one of the battery cells through at least one of the apertures and the at least one sidewall member out of the battery system. The venting path may include a conduit or a plenum downstream the channel. As described above, the apertures may be arranged in a top half of the channel, such that at least the bottom half of the channel may be adapted for collecting solid matter. In case of a thermal runaway, the venting gas typically carries solid matter along. A significant portion of the solid matter, which is carried by the venting gas along the at least one venting path, may settle in the bottom half of the channel within the at least one sidewall member after passing through the apertures. The venting gas (without or at least with less solid matter) is further directed out of the channel and out of the battery system. As the solid matter may include graphite particles (e.g., dust) and/or metallic fragments, a risk of a short circuit within the battery system or of a propulsion system in the environment of the battery system may be significantly reduced according to one or more embodiments of the present disclosure.

In some embodiments, a height of the channel is at least 70%, or more specifically at least 80% or at least 90% of a height of the chamber between the bottom and top cover. In some embodiments, the channel may have the same or substantially the same height as that of the chamber. The height of the channel is a sum of the height of the bottom half plus the height of the top half, the sum of the height of the bottom two thirds plus the height of the top third, or the sum of the height of the bottom three quarters plus the height of the top quarter of the channel. The height of the channel and the chamber may be measured perpendicular to or substantially perpendicular to the bottom cover and/or the top cover. The higher the channel, the better the possible separation of solid matter on the bottom of the channel, as the velocity at the bottom of the channel may be less when the channel is higher.

In some embodiments, besides the apertures, the chamber may be a hermetically (e.g., airtight) sealed chamber in order to protect the battery cells from environmental influences. Thus, the apertures may provide the only fluid connection between the chamber and an environment of the chamber and/or battery system.

In some embodiments, the top of the chamber and the top of the channel point to the same or substantially the same direction. Further, the bottom of the chamber and the bottom of the channel point to the same or substantially the same direction.

In some embodiments, the at least one sidewall member may include at least one gas guiding means. The at least one gas guiding means may be arranged inside the channel of the at least one sidewall member, and may be adapted to deflect the venting gas exiting the chamber through at least one of the apertures into a longitudinal direction of the channel along the at least one venting path. In other words, the at least one gas guiding means may direct the venting gas that exits the chamber via the aperture into a downstream direction of the at least one venting path. Thereby, the venting gas, and with it the solid matter, may be hindered from being swirled in a way such that the solid matter is prevented from re-entering the chamber upstream the channel and the at least one venting path. However, the gas guiding means within the channel may induce a vortex into the venting gas flow coming from upstream the gas guiding means through the channel, and thereby, facilitates the separation of the solid matter within the channel. Due to the vortex, the solid matter may be pushed against the sidewall profile where it is slowed down, and may sink to the bottom of the channel.

In some embodiments, the at least one gas guiding means may partially cover the at least one aperture, and may extend from an upstream edge of the at least one aperture into the channel. In other words the at least one gas guiding means may cover an upstream edge of the corresponding aperture, and may protrude at an angle from the inner wall of the sidewall member, which separates the chamber from the channel. Due to this structure, the aperture may be shielded by the at least one gas guiding means from venting products including the venting gas and the solid matter coming along the at least one venting path from upstream the channel. In other words, the venting products, which stream along the channel, may be hindered by the at least one gas guiding means to be prevented from re-entering the chamber via an aperture arranged downstream the channel.

The terms “downstream” and “upstream” refer to a streaming direction of the venting path starting in the chamber and ending in the environment of the battery system.

In some embodiments, the at least one gas guiding means may include a fin. The fin may also be referred to as a blade, for example, such as a guide blade. Thereby, the at least one gas guiding means may be realized in a simple and cost effective way.

In some embodiments, the at least one gas guiding means may be integrally formed with the at least one sidewall member. For example the gas guiding means may be partially stamped out of the at least one sidewall member, for example, from the inner wall of the at least one sidewall member, and may be bent into the channel. Thereby, costs of production may be further reduced.

In some embodiments, a hollow space may be provided between the battery cells and the top cover. In case of a thermal runaway, the venting products may stream through the hollow space to the apertures of the at least one sidewall member.

In some embodiments, a venting opening of each of the plurality of battery cells may point to (e.g., towards) the top cover. In other words, the top cover may be the cover of the battery housing to which the venting opening of each of the plurality of battery cells points. Thereby, in case of a thermal runaway event, the venting products may be vented from a corresponding battery cell on a direct way to the apertures, for example, directly into the hollow space between the battery cells and the top cover. Further, an upward direction within the battery system may be defined as a direction to which the venting openings of the plurality of battery cells point. Each venting opening may include a membrane, which bursts open at a suitable pressure (e.g., a predetermined pressure) inside the battery cell. As another example, or additionally, the upward direction within the battery system may be defined as a direction to which terminals (e.g., electrode terminals) of the plurality of battery cells point.

In some embodiments, the chamber may include at least two sub chambers. The at least two sub chambers may be thermally insulated and/or gas tightly separated. For example, the battery housing may include at least one partition wall, and the at least one partition wall may extend from the at least one sidewall member through the chamber, such that the chamber is separated into the at least two sub chambers. The at least one partition wall provides a thermally insulating and/or gas tight barrier between the at least two sub chambers. Due to the separation of the chamber into the at least two sub chambers by the partition wall, a thermal runaway within one of the sub chambers may be hindered from propagating into another one of the sub chambers. Accordingly, the venting products may be contained within the corresponding sub chamber. Thereby, the separated hollow space between the battery cells and the top cover may realize pipes through which the venting products are directed to the channel of the at least one sidewall member via the apertures. Thus, the venting gas and electrically conductive solid matter may be hindered from reaching an adjacent sub chamber, such that a short circuit of the battery cells within the adjacent sub chamber may be prevented or substantially prevented.

In some embodiments, the at least one sidewall member may include two sidewall members, for example, extending along opposite outer boundaries of the chamber. In other words, the chamber may be arranged between the two sidewall members. Thereby, venting products of at least one of the battery cells within the chamber may exit the chamber through both sidewall members. For example, in some embodiments, the partition wall may extend through the chamber from one of the sidewall members to the other sidewall member.

In some embodiments, the at least one sidewall member may include at least one aperture venting valve. The at least one aperture venting valve may close (e.g., may block or may cover) at least one of the apertures. For example, the aperture venting valve may be adapted to open at a suitable pressure (e.g., a predetermined pressure) inside the chamber, or at a suitable pressure difference (e.g., a predetermined pressure difference) between the chamber and the channel (e.g., when the higher pressure therebetween is within the chamber). In other words, the at least one aperture venting valve may be a venting valve that closes (e.g., blocks or covers) an aperture, and opens under over pressure of a battery cell in the thermal runaway (e.g., the venting gas pressure opens the aperture venting valve). Thereby, the venting gas expands into the sidewall frame profiles. Due to the at least one aperture venting valve, venting gas and solid matter within the channel may be prevented or substantially prevented from entering (e.g., re-entering) the chamber. In some embodiments, each of the apertures may be closed (e.g., blocked or covered) by a corresponding aperture venting valve.

In some embodiments, the aperture venting valves may be especially beneficial, for example, when the chamber is separated into sub chambers. In this case, only the at least one aperture venting valve of a sub chamber that accommodates a battery cell (or a battery cell row) affected by the thermal runaway may be opened. The at least one opened aperture venting valve may enable an expansion of the venting gas into the channel of the sidewall frame profile. Due to this activation of the dedicated at least one aperture venting valve, only the battery cells within the thermal runaway sub chamber (section) may be polluted. In case that each aperture is provided with an aperture venting valve, the remaining sub chambers, and the battery cells accommodated therein, may not be polluted, as they are still sealed by the aperture venting valves that remained closed, such that the not affected sub chambers may remain separated from the channel.

In some embodiments, the battery housing may include at least one housing opening, or at least one housing venting valve. For example, the battery housing may include one or two housing openings, or one or two housing venting valves. The at least one housing opening may be desired or suitable, for example, when all apertures are closed by the aperture venting valves, as the chamber is already sealed by the aperture venting valves. In this case, the venting path exits the battery housing through the at least one housing opening. Thus, no back pressure may be created within the channel. Thereby, the opening of the aperture venting valves of an affected sub chamber is facilitated, while an undesirable opening of a not affected sub chamber may be prevented or substantially prevented.

In some embodiments, the at least one aperture venting valve may include a membrane that closes (e.g., blocks or covers) the aperture. For example, the membrane may be adapted to burst open at a suitable pressure (e.g., a predetermined pressure) inside the chamber, or at a suitable pressure difference (e.g., a predetermined pressure) difference between the chamber and the channel.

In some embodiments, the housing venting valve may be adapted such that it opens at the suitable pressure (e.g., the predetermined pressure) within the chamber, the pressure being less than a pressure used or needed to open the at least one aperture venting valve. Thereby, it may be ensured that the aperture venting valves of the unaffected sub chambers are not opened accidentally by the over pressure within the channel created by a thermal runaway in an affected sub chamber.

In some embodiment, the membrane may include a foil, for example, such as an aluminum foil or a plastic foil. The plastic foil may include polytetrafluoroethylene (PTFE).

In some embodiments, the membrane may be adapted to melt at a temperature higher than 100° C., for example, such as higher than 200° C. or higher than 300° C. Thereby, a melting of the membrane due to the temperature of the venting gas inside the channel of the at least one sidewall member may be prevented or substantially prevented, such that apertures of the sub chambers that are not affected by the thermal runaway may stay closed.

In some embodiments, the aperture venting valve and/or the membrane may completely close the aperture, and thus, may seal the aperture. As another example, the membrane may include a perforation. Due to the perforation, the aperture may not be completely closed by the membrane, but may be partially closed, for example, such as mostly or substantially closed. Due to the perforation, a gas flow from the chamber to the channel may be enabled even before the membrane bursts open. The gas flow through the perforation may facilitate a weakening or even a melting of the membrane, as it may facilitate hot venting gas to reach the membrane. For example, in an embodiment, an area of the perforation may be less than 5%, for example, less than 2%. Further, in an embodiment, a melting point of the material of the membrane may be lower than the temperature of the venting gas that passes the perforation, but higher than the temperature of the venting gas after its expansion into the channel. Thereby a melting of the membranes of the sub chambers, which are not affected by the thermal runaway, may be prevented or substantially prevented. As another example, instead of the perforation, the membrane may be slotted. Thus, the membrane may include a slit, which on the one hand enables the gas flow through the membrane, but on the other hand enhances the separation of the chamber from the channel when compared to the perforation. This is because the slit may be substantially closed as long as there is no over pressure inside the chamber.

In some embodiments, the at least one sidewall member may include at least one membrane. The at least one membrane may at least partially close at least one of the apertures, and may be adapted to melt at or above a suitable temperature (e.g., a predetermined temperature), and thereby, to open the at least one aperture. The temperature may be a temperature reached when at least one battery cell within the chamber vents venting gas. Accordingly, in some embodiments, membrane may include the perforation, or may be slotted as described above.

In some embodiments, the at least one sidewall member may include an outlet port, for example, located downstream of the apertures of the channel. For example, in an embodiment, the outlet port may be located at a downstream end of the channel, and may be arranged in the top half of the channel. In other words, the outlet port may not extend below the upper half of the channel. Thus, the outlet port may be arranged only in the top half of the channel (e.g., may be restricted to the top half of the channel). At least the bottom half of the channel may be closed. For example, in an embodiment, the bottom half of the channel may be closed by a retention wall of the at least one sidewall profile (e.g., the at least one sidewall member). In other words, the venting gas of the venting products may only be exhausted from the channel through the outlet port, which may be arranged in the top half of the channel. Thus, the retention wall, which closes at least the bottom half of the sidewall profile, may hinder the solid matter from exiting the channel. For example, the outlet port may be arranged in the top third of the channel, or in the top quarter of the channel, for example, such that at least two bottom thirds, or three bottom quarters of the channel are closed, for example, by the retention wall of the at least one sidewall profile.

In some embodiments, the at least one sidewall member may include at least one rib, for example, such as a plurality of ribs, which may be arranged inside the bottom half of the channel transverse to a longitudinal direction of the channel. The at least one rib extends from the bottom of the channel upwards, and blocks the channel up to a height of the at least one rib. Thereby, solid matter that gets carried with the venting gas along the channel may sink to the bottom of the channel due to gravity, and may get caught by the ribs, which are arranged transverse to the longitudinal direction of the channel, and thus, transverse to the at least one venting path. In an embodiment, the ribs may be arranged perpendicularly or substantially perpendicularly to the longitudinal direction of the channel.

In some embodiments, the battery system may further include a particle separator arranged in the at least one venting path downstream of the channel. The particle separator may be arranged outside the battery housing, but it may be desirable for the particle separator to be arranged within the battery housing. The particle separator may be adapted to separate solid matter, which may still be present in the venting gas after leaving the channel, from the venting gas.

In some embodiments, the particle separator may be a centrifugal separator. Centrifugal separators are also known as cyclone separators. The centrifugal separator uses a centrifugal force to separate the solid matter from the venting gas.

In some embodiments, the centrifugal separator may be adapted to create a vortex around a center axis of the centrifugal separator, such that solid matter carried along by the venting gas may be separated from the venting gas radially while the venting gas exits the centrifugal separator axially along the center axis of the centrifugal separator. When the solid matter is separated from the venting gas radially, the solid matter may still include a tangential component of velocity. Due to the specific mass (e.g., the density) of the solid matter, which is higher than the specific mass of the venting gas, the solid matter may be thrown against an outer housing of the centrifugal separator, may be slowed down, and consequently, may be separated from the venting gas stream. The venting gas exits the centrifugal separator along the center axis in the center of the vortex, while the solid matter may not follow the venting gas due to its (specific) mass.

The center axis may be a vertical axis. For example, the venting gas may exit the centrifugal separator along the center axis in an upward direction. Accordingly, it may be even more likely that the solid matter is separated from the venting gas, as the solid matter would have to be carried away by the venting gas against gravity.

The battery cells may be rechargeable or secondary battery cells. The battery system may be suitable to power a propulsion system of a battery electric vehicle or a hybrid electric vehicle. The battery of the battery system may be denominated as a traction battery, for example, such as an electric-vehicle battery (EVB).

In some embodiments, the battery system, particularly the battery housing, may have a flat or substantially flat shape. In other words, a height of the battery system, particularly of the battery housing, may be smaller than its width or length. For example, in an embodiment, the height may be less than a third, or in more detail, less than a quarter of the width or length. In order to accommodate a sufficient number of battery cells within the battery housing despite the flat shape, a length and a width of the battery housing may be relatively large compared to its height. Accordingly, a relatively long at least one sidewall member, and thus, a relatively long channel inside the at least one sidewall member, may be realized. The longer the channel, the better its effect in separating solid matter.

In some embodiments, a vehicle including the battery system described according to one or more embodiments above may be provided. The battery system may be integrated into an underbody construction of the vehicle, which allows the battery system to have a substantially flat shape. Accordingly, in case of a thermal runaway, an amount of exhausted solid matter, which may include electrically conductive dust, may be significantly reduced. Thereby, an occurrence of short circuits may be largely reduced or prevented.

In some embodiments, the at least one venting path exits the vehicle in front of a passenger cabin of the vehicle. Thereby, the venting products may exit the battery system into a front section and/or engine bay of the vehicle (e.g., an automobile or car), for safe access to the passenger cabin and rear trunk.

In some embodiments, a battery system including a plurality of battery cells may be provided, wherein the battery system includes a venting path leading from a chamber, which accommodates the plurality of battery cells, to an environment of the battery system. The battery system includes a centrifugal separator within the venting path. For example, the centrifugal separator includes at least one of the features related to the centrifugal separator described in the present disclosure.

In some embodiments, a centrifugal separator for a battery system may be provided. For example, the centrifugal separator may include at least one of the features related to the centrifugal separator described in the present disclosure.

The above and other aspects and features of the present disclosure may be learned from the description that follows with reference to the figures, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting example embodiments with reference to the accompanying drawings, in which:

FIG. 1 illustrates a schematic top view and sectional views of a battery system according to an embodiment;

FIG. 2 illustrates a schematic top view and sectional views of a battery system according to another embodiment; and

FIG. 3 illustrates a schematic top view of a vehicle including the battery system according to an embodiment.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. For example, if the term “substantially” is used in combination with a feature that could be expressed using a numeric value, the term “substantially” may denote a range of +/−5% of the value centered on the value. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

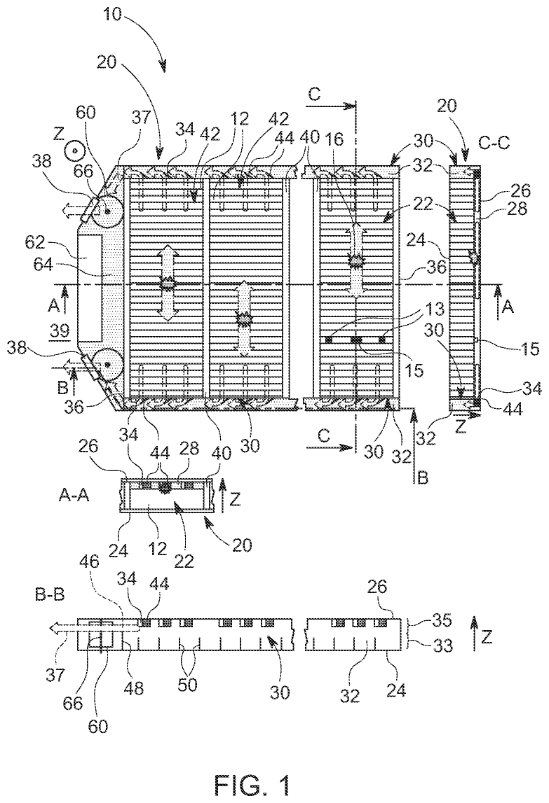

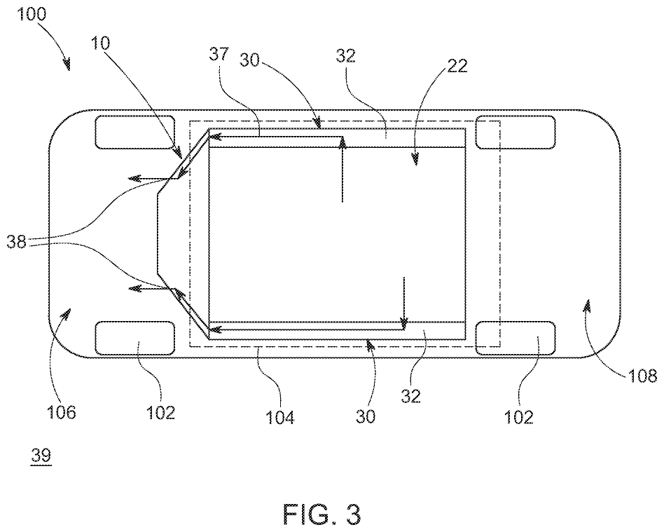

FIG. 1 illustrates a schematic top view and sectional views along the lines A-A, B-B, and C-C of a battery system 10 according to an embodiment. The battery system 10 is suitable for a vehicle 100 (e.g., see FIG. 3), and includes a plurality of battery cells 12 and a battery housing 20 (a battery pack housing).

The battery housing 20 includes a chamber 22 arranged (e.g., sandwiched) between a bottom cover 24 (e.g., a battery bottom cover plate) and a top cover 26 (e.g., a battery top cover plate) of the battery housing 20. The chamber 22 accommodates the plurality of battery cells 12. The top cover 26 may be referred to as an upper housing cover, and the bottom cover 24 may be referred to as a lower housing cover. The battery cells 12 are arranged inside the chamber 22, such that a hollow space 28 is provided between the battery cells 12 and the top cover 26.

According to the present embodiment, the battery cells 12 may be prismatic battery cells 12, which may be arranged in rows. Each battery cell 12 includes two terminals 13 (e.g., electrode terminals), which are connected with electrodes of the battery cell 12. The terminals 13 are electrically connected in parallel and/or in series. The terminals 13 of the battery cells 12 point to (e.g., face in) an upper direction along a z-axis, and thus, the terminals 13 point into a z-direction and toward the top cover 26.

The battery cells 12 each include a venting opening 15 for allowing venting products produced in an abnormal operation condition, also known as a thermal runaway 16 or a thermal event, to be released from the battery cells 12 when an overpressure (e.g., a predetermined or certain overpressure) and/or a temperature (e.g., a predetermined or certain temperature) inside affected ones of the battery cells 12 are exceeded. This vent opening 15 may usually be covered by a membrane that bursts open when a pressure inside the battery cell 12 exceeds a pressure threshold (e.g., a predetermined pressure threshold). The position of the vent openings 15 relative to the battery cells 12 may be used to define the z-axis, or in more detail, the vent openings 15 may point in the direction of the z-axis and towards the top cover 26. In other words, the venting openings 15 point to an upper direction. In the top view of FIG. 1, the z-axis points out of the drawing plane. In the partial sectional view along the line A-A and the sectional view along the line B-B, the z-axis points upwards (e.g., towards the top) of the drawing plane, and in the sectional view C-C, the z-axis points to the right side of the drawing plane. As used herein, the terms “top”, “bottom”, “upper”, and “lower” are defined according to the z-axis. For example, the top cover 26 is positioned at the upper part of the z-axis, and the bottom cover 24 is positioned at the lower part of the z-axis. According to the embodiment shown in FIG. 1, the terminals 13 and/or venting openings 15 of all battery cells 12 of the battery system 10 are arranged on top of the battery cells 12, and thus, point to the same direction (e.g., the z-direction) as each other. Thus, the terminals 13 and/or the venting openings 15 of all battery cells 12 of the battery system 10 point to the top cover 26.

The battery housing 20 includes at least one sidewall member 30, which connects the bottom cover 24 and the top cover 26 to each other. The at least one sidewall member 30 extends along an outer boundary of the chamber 22, and includes a channel 32 inside the at least one sidewall member 30. The sidewall member 30 is a sidewall frame profile, which improves a structural stiffness of the battery housing 20. The at least one sidewall member 30 includes apertures 34 (e.g., openings) connecting the chamber 22 with the channel 32. The apertures 34 are arranged in a top half 35 of the channel 32 next to (e.g., adjacent to) the top cover 26, such that at least a bottom half 33 of the channel 32 is adapted for collecting solid matter. The top half 35 of the channel is positioned at the upper part of the z-axis, and the bottom half 33 of the channel is positioned at the lower part thereof. The apertures 34 perforate an inner wall (e.g., arranged between the channel 32 and the chamber 22) of the at least one sidewall member 30, such that a fluid connection between the chamber 22 and the at least one channel 32 is established. At least the bottom half 33 of the perforated inner wall of the sidewall member 30 separates the chamber 22 from the channel 32. This is because at least the bottom half 33 of the inner wall does not include any apertures, and thus, at least the lower half 33 of the channel 32 is airtight separated from the chamber 22. As the apertures 34 are arranged only in the top half 35 of the channel 32, a collecting channel is realized by at least the bottom half 33 of the channel 32 (e.g., see the sectional view along the line B-B).

According to the embodiment shown in FIG. 1, the at least one sidewall member 30 includes (e.g., is formed of) two sidewall members 30 extending along opposite outer boundaries (e.g., opposite outer sides) of the chamber 22, and both of the sidewall members 30 connect the bottom cover 24 with the top cover 26. Each of the two sidewall members 30 includes the features and functionality of the described “at least one sidewall member 30” herein. Also, when features are described in relation to both sidewall members 30, these features are also applicable to just one single sidewall member 30 or the “at least one sidewall member 30”. A front side and a rear side of the chamber 22 may be closed by two endwall members 36. The two endwall members 36 extend along opposite outer boundaries of the chamber 22. Each of the two endwall members 36 connects the two sidewall members 30 with each other, and connects the top cover 26 and the bottom cover 24 with each other. As another example, instead of the two endwall members 36, two further sidewall members 30, each including a channel 32 and apertures 34, may be used to close the chamber 22.

While under regular operating conditions, the battery housing 20 encloses the battery cells 12 in a gas tight or substantially gas tight manner (e.g., an essentially gas tight manner). However, in case of the thermal runaway 16, venting gas is vented from at least one of the battery cells 12, and may be exhausted out of the chamber 22 and the battery housing 20 in order to avoid damage to the battery housing 20 and a further propagation of the thermal runaway 16. Therefore, the battery system 10 is adapted such that in case of the thermal runaway 16, a venting gas that is vented from at least one of the battery cells 12 is directed along at least one venting path 37 (e.g., the venting path extends along the arrows in FIGS. 1 to 3) leading out of the battery system 10. As the embodiment shown in FIG. 1 includes two sidewall members 30, each including a channel 32, two venting paths 37 are realized. Each of the venting paths 37 leads from a battery cell 12 in the thermal runaway 16 inside the chamber 22, through the apertures 34 and the channel 32 inside the at least one sidewall member 30, to an environment (e.g., an external environment) of the battery system 10. The venting path 37 exits the battery housing 20 through a housing venting valve 38, which is closed while under regular operating conditions, and the housing venting valve 38 is opened in case of the thermal runaway 16, for example, such as by an increased internal pressure within the battery housing 20. Such an opening may also allow for draining away the venting gas safely in order to protect persons from fumes that may occur during the thermal runaway 16 (venting) or other dysfunctions of the battery cells 12 within the battery housing 20. The housing venting valve 38 connects the at least one venting path 37 with an environment (e.g., an external environment) 39 of the battery system 10.

As shown in FIG. 1, each of the venting paths 37 is branched in order to penetrate the inner walls of the sidewall members 30 through the apertures 34.

Due to the high pressures and temperatures inside a battery cell 12 while the thermal runaway 16 occurs, solid matter, for example, such as graphite powder and/or metallic fragments originating from the electrodes of the battery cells 12, may get carried away (e.g., may be picked up and flow) with the venting gas. Graphite powder and metallic fragments pose a risk for short circuits within the battery system 10 or a vehicle including the battery system 10. For example, when a short circuit is caused by an Aluminum fragment, there may be a chance that the Aluminum fragment melts, and subsequently, the short circuit may be opened. However, in the case of graphite powder, there is a risk that when graphite powder closes a short circuit, the graphite powder may sinter such that the short circuit may be maintained. Thus, on the one hand, it is important to release the venting gas out of the battery system, while on the other hand, the solid matter should be retained within the housing and kept away from electric and electronic components.

Therefore, according to an aspect of at least one embodiment of the present disclosure, when the venting gas is guided along the venting path 37 through the battery system 10, the solid matter that is carried away by the venting gas settles within the channels 32 of the sidewall members 30. This may be possible because the apertures 34 are arranged in the top half 35 of the channel 32, such that at least the bottom half 33 of each channel 32 is adapted as a collecting channel for collecting the solid matter. The venting gas that carries the solid matter into the channels 32 flows through the apertures 34 at a relatively high velocity. When the venting gas enters the channels 32 through the apertures 34, the venting gas expands, and therefore, its velocity is reduced. The reduction of the velocity promotes a gravity driven separation of the solid matter from the venting gas within the channels 32. Therefore, the sidewall members 30 and their channels 32 act as expansion chambers to slow down the venting gas flow, as well as a container to store metallic parts and graphite escaping from the battery cells 12 in the thermal runaway 16.

The battery housing 20 includes partition walls 40, and the partition walls 40 extend from the at least one sidewall member 30 through the chamber 22, such that the chamber 22 is separated into at least two sub chambers 42. As shown in the top view of FIG. 1, multiple (e.g., a plurality of) partition walls 40 connect between the two sidewall members 30, such that the partition walls 40 are arranged between the sub chambers 42. The partition walls 40 separate the sub chambers 42 in a thermally isolating and gas tight manner. Therefore, the partition walls 40 prevent or substantially prevent any sort of thermal propagation to the remaining (e.g., not affected) cell rows, and contain the thermal runaway 16 within one of the sub chambers 42, such that, for example, just the one single sub chamber 42 is affected. Thereby a thermal propagation through the whole battery may be prevented or substantially prevented. Also the top cover 26 is shielded by a thermal resistant plate, which also provides an electric isolation, and is placed on the inside of the battery housing 20. The partition walls 40, which are frame parts inside the battery housing 20, also separate the hollow space 28 provided between the battery cells 12 (e.g., a cover of the battery cells 12) and the top cover 26 into venting pipes above the individual rows of battery cells 12. Due to these venting pipes, only the battery cells 12 within the thermal runaway sub chamber 42 may be polluted as the venting products are guided within the venting pipes. The remaining cell rows within the remaining sub chambers 42 may not be polluted. The partition walls 40 may be realized by cell holders. A first portion of the venting gas, which exits a battery cell 12, is clean and builds up an internal pressure within the sub chambers 42 that are not affected by the thermal runaway. Thus, following (dusty) venting gas including the solid matter will not enter those other sub chambers 42, which remain clean (e.g., unpolluted).

The sidewall members 30 include gas guiding means 44 arranged inside the channels 32, and thus, inside the sidewall members 30. The gas guiding means 44 are adapted to deflect the venting products exiting the chamber 22 through the apertures 34 into a longitudinal direction of the channels 32 along the at least one venting path 37 (e.g., see the bent arrows in the top view of FIG. 1). According to the embodiment shown in FIG. 1, the gas guiding means 44 may include fins 44. The gas guiding means 44 partially cover the apertures 34, and extend from an upstream edge of each aperture 34 into the channels 32. Besides deflecting the venting products exiting the chamber 22 into the longitudinal direction of the channels 32, the gas guiding means 44 may hinder solid matter that is carried along the channel 32 with the venting gas from entering a downstream arranged aperture 34 and a corresponding sub chamber 42. Without the gas guiding means 44, the solid matter expelled by an upstream sub chamber 42 (e.g., related to the venting path 37) could intrude into a downstream sub chamber 42, which may not be affected by the thermal runaway 16, and could cause a short circuit. Due to the gas guiding means 44, the intrusion of solid matter into a downstream aperture 34 and/or sub chamber 42 may be prevented or at least reduced.

The gas guiding means 44 are integrally formed with the at least one sidewall member 30. The sidewall member 30 is a hollow aluminum profile, and the fins 44 are stamped out from a wall of the sidewall member 30. In more detail, each fin 44 is stamped along a circumference of the fin 44 and/or aperture 34, except an upstream edge of the fin 44 and aperture 34. After stamping, the fins 44 are bent inwards from the channel 32, such that the fins 44 are angled to the wall of the sidewall member 30.

The sectional view along the line B-B of FIG. 1 is a view along one of the venting paths 37 downstream the chamber 22. As shown in the sectional view along the line B-B of FIG. 1, the sidewall members 30 each include an outlet port 46 arranged downstream the apertures 34 at a downstream end of each channel 32. The outlet port 46 is arranged in the top half 35 of the channel 32, such that at least the bottom half 33 of the channel 32 is closed by a retention wall 48 of the at least one sidewall member 30. The retention wall 48 facilitates the retention of solid matter within the channels 32, as it closes (e.g., blocks) at least the bottom half 33 of the channel 32. In the sectional view along the line B-B of FIG. 1, the outlet port 46 is arranged directly above the retention wall 48. The outlet port 46 may be realized by a gap between the retention wall 48 and the top cover 26, or by an opening penetrating through the retention wall 48.

The sidewall member 30 includes ribs 50 arranged inside the bottom half 33 of the channel 32. The ribs 50 are arranged transverse to a longitudinal direction of the channel 32. The ribs 50 extend upward from a bottom of a channel 32, such that at least the upper half 35 of the channel 32 remains unblocked. The ribs 50 facilitate the retention of the solid matter within the channels 32.

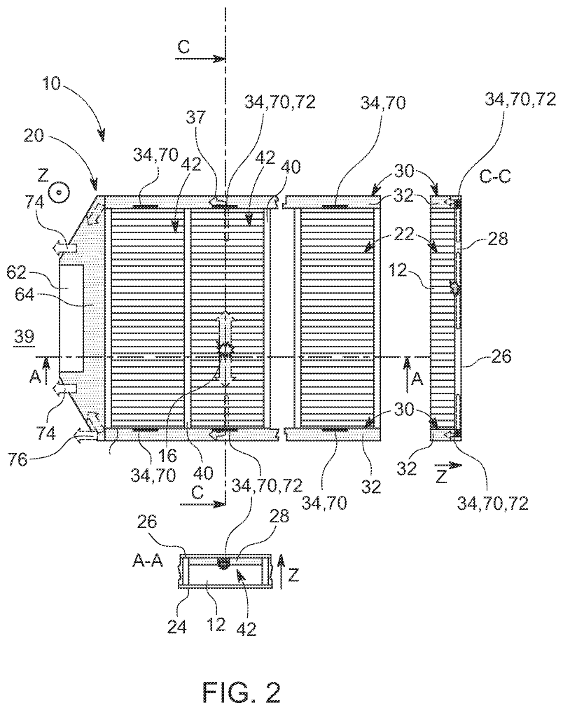

The battery system 10 further includes particle separators 60, one particle separator 60 being arranged in each of the venting paths 37 downstream of the channels 32. As another example, the battery system 10 may include just one single particle separator 60 for both venting paths 37. In other embodiments (e.g., see FIG. 2), the particle separators 60 are omitted. The particle separators 60 are arranged inside the battery housing 20. For example, the particle separators 60 may be arranged at (e.g., in or on) opposite sides (e.g., both sides) of a junction box 62 within a separation area 64 (e.g., a filter area). The separation area 64 acts as a filter, and is arranged at (e.g., in or on) a front section of the battery system 10. As another example, the particle separators 60 may be arranged outside the battery housing 20. The dotted area within the separation area 64 including the particle separators 60 shown in the figures symbolizes an area through which the venting gas including the solid matter may flow within the separation area 64. For example, if the particle separators 60 are omitted, the whole dotted separation area 64 may be used for other particle separation means. When at least one particle separator 60 is provided, then the at least one particle separator 60 may be connected to the channel 32 of the at least one sidewall member 30 and to the housing venting valve 38 via conduits. In this case, the venting path 37 may be adapted such that the venting gas may not stream through the dotted area of the separation area 64 outside the particle separators 60.

The particle separators 60 are centrifugal separators 60 adapted to create a vortex around a center axis 66, which is a vertical axis extending along the z-axis, such that solid matter is separated from the venting gas radially while the venting gas exits the centrifugal separator 60 axially along the center axis 66 in the center of the vortex. The vortex is created by the velocity of the vented gas, and thus, no motor may be used or needed to create the vortex. The particle separator 60 effects a further reduction of the solid matter exhausted by the battery system 10. The venting gas exits the centrifugal separator 60 along the center axis 66 in an upward direction, such that gravity further facilitates the separation of the solid matter from the venting gas.

FIG. 2 illustrates a schematic top view, a partial sectional view along the line A-A, and a sectional view along the line C-C of a battery system 10 according to another embodiment. The embodiment illustrated in FIG. 2 may differ from the embodiment illustrated in FIG. 1 by the following features described in more detail hereinafter, and redundant description thereof may not be repeated.

The two sidewall members 30 include aperture venting valves 70, and the aperture venting valves 70 close the apertures 34. The aperture venting valves 70 are adapted to open at a suitable pressure difference (e.g., a predetermined pressure difference) between each sub chamber 42 and the channels 32.

The aperture venting valves 70 are membranes, for example, such as foils, which close the apertures 34, and may burst open at the suitable pressure difference (e.g., the predetermined pressure difference) between the corresponding sub chamber 42 and the channel 32.

Thus, the venting structure according to FIG. 2 includes dedicated aperture venting valves 70 for each sub chamber 42, and therefore, for each battery cell row. Further, the venting paths 37 (e.g., symbolized by bold arrows) are formed by covers (e.g., top covers) of the battery cells 12, the partition walls 40 (e.g., cell holders), the top cover 26 of the battery (e.g., battery pack) housing 20, the sidewall members 30, which are realized by hollow sidewall frame profiles, and the separation area 64, which is a front section of the battery. Thereby, contamination of the remaining battery components, which are not directly affected by the thermal runaway 16, with graphite and metallic parts of the battery cell 12 during the thermal runaway 16 may be prevented or substantially prevented. Only the aperture venting valves 70, 72 of the branch with the battery cell 12 in the thermal runaway 16 condition will be opened because of the gas pressure. The aperture venting valves 70, 72 of the remaining branches, which are not affected, may remain closed, and therefore, the remaining branches may not be polluted.

The embodiment according to FIG. 2 may include one or two housing openings 74, which remain (e.g., are always) open (e.g., an always open section). The housing openings 74 connect the venting paths 37 with the environment 39 of the battery system 10. The venting path 37 is adapted such that a dedicated flow of the venting gas starts at the battery cell 12 in the thermal runaway 16 and flows along the cell row, through the dedicated opened aperture venting valve 72, along the channel 32 in the inside of the sidewall member 30 and through the separation area (e.g., the separation chamber) 64, and exits the battery system 10 through the housing openings 74. As another example to the housing openings 74, the battery housing 20 may include alternative housing openings 76, which may be the same or substantially the same as the housing openings 74 except for their position in the battery housing 20. The alternative housing openings 76 may be arranged immediately downstream the channel 32, such that the separation area 64 is mostly bypassed or no separation area 64 is provided. Although just one alternative housing opening 76 is depicted in FIG. 2, a second alternative housing opening 76 may be provided at a symmetrical or substantially symmetrical position immediately downstream the channel 32 of the opposite sidewall member 30. The venting paths 37 do not have to be branched, for example, when just one aperture 34 per sidewall member 30 and sub chamber 42 is provided (e.g., see FIG. 2). As the housing openings 74 or 76 may not create a back pressure within the channels 32, the opening of the aperture venting valves 70, which seal a sub chamber 42 affected by a thermal runaway 16, is facilitated. The housing openings 74, 76 may include a grid that covers the housing openings 74, 76. Thereby, animals are hindered from entering the battery housing 20 through the housing openings 74, 76. The grid may include a (relatively low) melting point, such that it melts when venting gas exits the housing openings 74 via the grid. Thereby the grid may not be obstructed by solid matter carried along by the venting gas.

As another example to the housing openings 74 or 76, the battery housing 20 may include at least one housing venting valve 38 (e.g., schematically shown in FIG. 1).

The housing venting valve 38 is adapted such that it opens at a suitable pressure (e.g., a predetermined pressure), wherein the pressure is less than a pressure needed to burst the membranes of the aperture venting valves 70. Thereby, the housing venting valve 38 may be ensured to open before membranes of aperture venting valves 70 of sub chambers 42, which are not affected by a thermal runaway 16, burst open. Thus, independently of the choice of such an adapted housing venting valve 38 or housing opening 74 or 76, only those aperture venting valves 70, 72 of the cell row affected by the thermal runaway 16 are opened, and the other aperture venting valves 70, 72 remain closed to seal the unaffected cell rows.

In summary, the thermal separation of an affected cell row (e.g., sub chamber 42) from the remaining cell rows may prevent or substantially prevent a burn down of the complete pack. To reduce the pressure within an affected sub chamber 42, the venting gas pressure opens the dedicated aperture venting valves 70, 72 of the cell row in the thermal runaway condition. Thereby an expansion into the sidewall members 30 and further into an open exit, like the housing openings 74, 76, reduces the overall pressure. The aperture venting valves 70 of the other cell rows remain closed and are not polluted by the dust carried along by the venting gas.

FIG. 3 illustrates a schematic top view of a vehicle 100 including the battery system 10 according to an embodiment. The vehicle 100 may be an electric vehicle, and the battery system 10 may be arranged at (e.g., in or on) an underbody area of the vehicle 100. As another example, the vehicle 100 may be a hybrid electric vehicle 100. The vehicle may be an automobile (e.g., a car), and thus, may include four wheels 102.

According to the present embodiment, a z-axis of the vehicle 100 corresponds to the z-axis of the battery system 10. Both the z-axis of the vehicle 100 and of the battery system 10 point to an upper direction of the vehicle 100. As FIG. 3 shows a top view of the vehicle 100 and of the battery system 10, the z-axis of the vehicle 100 and of the battery system 10 are perpendicular to or substantially perpendicular to the drawing plane, and points out of the drawing plane.

The venting paths 37 of the battery system 10 exit the vehicle 100 in front of a passenger cabin 104 of the vehicle 100. Thus, the venting gas exits the vehicle 100 through a front section 106, for example, such as an engine bay, of the vehicle 100, for safe access to the passenger cabin 104 and rear trunk 108.

Although some example embodiments have been described, those skilled in the art will readily appreciate that various modifications are possible in the example embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific example embodiments disclosed herein, and that various modifications to the disclosed example embodiments, as well as other example embodiments, are intended to be included within the spirit and scope of the present disclosure as defined in the appended claims, and their equivalents.

### REFERENCE SYMBOLS

10 battery system
12 battery cell
13 terminal
15 venting opening
16 thermal runaway
20 battery housing
22 chamber
24 bottom cover
26 top cover
28 hollow space
30 sidewall member
32 channel
33 bottom half of channel
34 aperture
35 top half of channel
36 endwall member
37 venting path
38 housing venting valve
39 environment
40 partition wall
42 sub chamber
44 gas guiding means/fins
46 outlet port
48 retention wall
50 ribs
60 particle separator/centrifugal separator
62 junction box
64 separation area
66 center axis
70 aperture venting valve
72 opened aperture venting valve
74 housing opening
76 alternative housing opening
100 vehicle
102 wheels
104 passenger cabin
106 front section
108 rear trunk

What is claimed is:

1. A battery system comprising:
a plurality of battery cells; and
a battery housing comprising:
a chamber between a bottom cover and a top cover of the battery housing, the chamber being configured to accommodate the plurality of battery cells; and
at least one sidewall member connecting the bottom cover and the top cover to each other, the at least one sidewall member extending along an outer boundary of the chamber, and comprising:
a channel inside the sidewall member; and
apertures connecting the chamber with the channel, the apertures being located at a top half of the channel such that at least a bottom half of the channel is configured for collecting solid matter;
wherein the battery system is configured to vent a venting gas of a thermal runaway from at least one of the battery cells by directing the venting gas along at least one venting path leading from the chamber, through at least one of the apertures and the channel, and to an environment of the battery system.

2. The battery system of claim 1, wherein the at least one sidewall member comprises at least one gas guiding means inside the channel of the at least one sidewall member, the at least one gas guiding means being configured to deflect the venting gas exiting the chamber through at least one of the apertures into a longitudinal direction of the channel along the at least one venting path.

3. The battery system of claim 2, wherein the at least one gas guiding means partially covers the at least one aperture, and extends from an upstream edge of the at least one aperture into the channel.

4. The battery system according to claim 2, wherein the at least one gas guiding means comprises a fin.

5. The battery system according to claim 2, wherein the at least one gas guiding means is integrally formed with the at least one sidewall member.

6. The battery system according to claim 1, wherein a hollow space is defined between the battery cells and the top cover.

7. The battery system according to claim 1, wherein the battery housing comprises at least one partition wall extending from the at least one sidewall member through the chamber to separate the chamber into at least two sub chambers.

8. The battery system according to claim 1, wherein the at least one sidewall member comprises two sidewall members extending along opposite outer boundaries of the chamber.

9. The battery system according to claim 1, wherein the at least one sidewall member comprises at least one aperture venting valve closing at least one of the apertures, and configured to open according to a pressure inside the chamber.

10. The battery system according to claim 1, wherein the at least one sidewall member comprises:
an outlet port located at the top half of the channel; and
a retention wall blocking at least the bottom half of the channel.

11. The battery system according to claim 1, wherein the at least one sidewall member comprises at least one rib located inside the bottom half of the channel transverse to a longitudinal direction of the channel.

12. The battery system according to claim 1 further comprising a particle separator in the at least one venting path downstream of the channel.

13. The battery system of claim 12, wherein the particle separator comprises a centrifugal separator.

14. A vehicle comprising the battery system of claim 1.

15. The vehicle of claim 14, wherein the at least one venting path is configured to exit the vehicle at a front of a passenger cabin of the vehicle.
